(19) United States
(12) Patent Application Publication
(10) Pub. No.: US 2026/0237189 A1
(43) Pub. Date: Aug. 13, 2026

(54) CAMERA-SPECIFIC EMBEDDINGS IN BIRDS-EYE-VIEW NEURAL NETWORK

(71) Applicant: QUALCOMM Incorporated, San Diego, CA (US)

(72) Inventor: Jesper Westell, Linköping (SE)

(21) Appl. No.: 19/050,530

(22) Filed: Feb. 11, 2025

(51) Int. Cl. G06V 10/77; G06V 10/774; G06V 10/80; G06V 10/82; G06V 20/56

(52) U.S. Cl. CPC G06V 10/7715; G06V 10/774; G06V 10/806; G06V 10/82; G06V 20/56

(57) ABSTRACT

An apparatus for processing image data includes a memory for storing the image data and processing circuitry in communication with the memory. The processing circuitry is configured to obtain image data including a current set of multiple camera images from multiple cameras. According to such an example, the apparatus may also generate respective feature vectors from each of the multiple camera images with a shared image feature encoder using camera-specific positional embeddings associated with different respective cameras used to capture the multiple camera images. The apparatus may also perform a perception task using the respective feature vectors.

### TECHNICAL FIELD

This disclosure relates to image processing, including image data for use in advanced driver-assistance systems (ADAS).

### BACKGROUND

An autonomous driving vehicle is a vehicle that is configured to sense the environment around the vehicle, such as the existence and location of objects, and to operate without human control. An autonomous driving vehicle may include cameras that produce image data that may be analyzed to determine the existence and location of other objects around the autonomous driving vehicle. A vehicle having advanced driver-assistance systems (ADAS) is a vehicle that includes systems which may assist a driver in operating the vehicle, such as parking or driving the vehicle.

### SUMMARY

The present disclosure generally relates to techniques and devices for processing image data from multiple cameras to improve feature extraction and subsequent Birds-Eye-View (BEV) projection. For example, aspects of the disclosure include processing multiple images from multiple cameras of a vehicle utilizing a single shared image feature encoder and extracting features from the multiple images at inference time utilizing camera-specific positional embeddings used to train the shared image feature encoder during training. Such extracted feature vectors may also be transformed and projected into a BEV grid based on distinct characteristics learned for each of the multiple cameras. Training a single shared image feature encoder utilizing image data from multiple distinct camera sources, as well as the camera-specific positional embeddings (e.g. as opposed to training multiple encoders corresponding to each of the multiple camera sources), enables weight sharing within the shared image feature encoder which may increase robustness against model variance, especially with limited datasets. Because each camera is trained with the same network using a different embedding for each camera, the network may be tuned for each individual camera using the different embeddings.

The camera-specific positional embeddings used during training may be constructed using a set of sinusoids. The length of each camera-specific positional embedding depends on the layer output of the shared image feature encoder to which a respective sinusoid is applied. The sinusoid may be added element-wise to match the dimensions of the layer output or concatenated to increase dimensionality. In some examples, camera-specific positional embeddings may be initialized using one-hot encoding, where each embedding is represented by a unique one-hot vector (e.g., the first embedding as [1,0,0,0, . . . ], the second as [0,1,0,0, . . . ], the third as [0,0,1,0, . . . ], and the fourth as [0,0,0,1, . . . ], and so on). These embeddings can either remain fixed throughout training or be updated iteratively as learnable parameters. Alternatively, the positional embeddings may be randomly initialized and learned during training without constraints from one-hot encoding

During inference time, processing circuitry may generate respective feature vectors from each of the multiple camera images with the shared image feature encoder using the camera-specific positional embeddings associated with different respective cameras used to capture the multiple camera images. Because the camera-specific positional embeddings used during training are each associated with one of the different respective cameras, the shared image feature encoder may leverage these embeddings to maintain camera-specific feature distinctions. For instance, use of the embeddings may allow a shared image feature encoder to be fine-tuned for specific cameras without using completely separate feature extractors. Processing circuitry may subsequently perform a perception task using the respective feature vectors. Processing circuitry may also project the features into a Bird's-Eye-View (BEV) grid space using a BEV network to enable useful downstream tasks. For instance, an advanced driver-assistance system (ADAS) may be configured to control a vehicle utilizing the output provided by the perception task(s) performed and/or utilizing the BEV grid space.

In one example, an apparatus for processing image data includes a memory for storing the image data. The apparatus also includes processing circuitry in communication with the memory. In one example, the processing circuitry is configured to obtain the image data, including a current set of multiple camera images from multiple cameras. According to certain examples, the processing circuitry is configured to generate respective feature vectors from each of the multiple camera images with a shared image feature encoder using camera-specific positional embeddings associated with different respective cameras used to capture the multiple camera images. In at least one example, the processing circuitry is configured to perform a perception task using the respective feature vectors.

In another example, a method of processing image data includes obtaining image data, including a current set of multiple camera images from multiple cameras. In one example, the method includes generating respective feature vectors from each of the multiple camera images with a shared image feature encoder using camera-specific positional embeddings associated with different respective cameras used to capture the multiple camera images. According to such examples, the method includes performing a perception task using the respective feature vectors.

In another example, a non-transitory computer-readable medium stores instructions that, when executed, cause processing circuitry to obtain image data, including a current set of multiple camera images from multiple cameras. In one example, the non-transitory computer-readable medium stores instructions that, when executed, cause processing circuitry to generate respective feature vectors from each of the multiple camera images with a shared image feature encoder using camera-specific positional embeddings associated with different respective cameras used to capture the multiple camera images. According to certain examples, the non-transitory computer-readable medium stores instructions that, when executed, cause processing circuitry to perform a perception task using the respective feature vectors.

In another example, a device for processing image data includes means for obtaining image data, including a current set of multiple camera images from multiple cameras. In one example, the device includes means for generating respective feature vectors from each of the multiple camera images with a shared image feature encoder using camera-specific positional embeddings associated with different respective cameras used to capture the multiple camera images. According to such examples, the device includes means for performing a perception task using the respective feature vectors.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example processing system, in accordance with one or more techniques of this disclosure.

FIG. 2 is a block diagram illustrating an architecture for processing camera images from multiple distinct cameras through shared image view network to generate extracted feature vectors based on camera-specific positional embeddings used to train shared image view network, in accordance with one or more techniques of this disclosure.

FIG. 3 is a conceptual diagram for generating camera-specific positional embeddings for a shared image feature encoder from a set of fixed embeddings, in accordance with one or more techniques of this disclosure.

FIG. 4 is a flow diagram illustrating an example method for processing image data from multiple cameras, in accordance with one or more techniques of this disclosure.

### DETAILED DESCRIPTION

Prior techniques for Birds-Eye-View (BEV) perception models transform camera-specific features into a shared BEV feature space for use by other downstream tasks to interpret the scene captured by such cameras, such as an environment around an autonomous vehicle. For instance, extracted feature vectors projected into the shared BEV feature space may be utilized to enable decision making for an assisted driving system or an autonomous driving system. In addition to performing perspective-to-BEV transformations, BEV network models may incorporate camera-specific feature information into the shared BEV feature space. For instance, in a four-camera surround system covering the front, left, right, and rear views of a vehicle, prior known BEV models may apply four individual camera-specific encoders. Because each of the four individual encoders are trained to process camera images from a single source camera, it is known, a priori, by each of the four individual encoders, which of multiple cameras is a source camera, as there is only one source provided to each of the four individual encoders. However, such an arrangement does not allow for the beneficial sharing of network weights amongst the multiple individual encoders. Moreover, training four separate encoders is computationally expensive and training data for the four separate encoders is limited due to the lack of sharing of the training data amongst the separate encoders and due also to the varying arrangement of camera configurations across different vehicles.

Processing the image data from multiple distinct cameras through a shared image view network utilizing camera-specific positional embeddings enables the shared image view network to apply distinct characteristics associated with each of the respective cameras to feature vector extraction processing while also enabling the single shared image view network to share network weights for the extracted feature vectors from the multiple camera images.

The present disclosure generally relates to techniques and devices for processing image data from multiple cameras to improve feature extraction and subsequent Birds-Eye-View (BEV) projection. For example, aspects of the disclosure include processing multiple images from multiple cameras of a vehicle utilizing a single shared image feature encoder and extracting features from the multiple images at inference time utilizing camera-specific positional embeddings used to train the shared image feature encoder during training. Such extracted feature vectors may also be transformed and projected into a BEV grid based on distinct characteristics learned for each of the multiple cameras. Training a single shared image feature encoder utilizing image data from multiple distinct camera sources, as well as the camera-specific positional embeddings (e.g. as opposed to training multiple encoders corresponding to each of the multiple camera sources), enables weight sharing within the shared image feature encoder which may increase robustness against model variance, especially with limited datasets. Because each camera is trained with the same network using a different embedding for each camera, the network may be tuned for each individual camera using the different embeddings.

The camera-specific positional embeddings used during training may be formed using a set of sinusoids. The length of each of the camera-specific positional embeddings varies depending on the layer output of the shared image feature encoder to which a respective sinusoid is applied. The sinusoid may be added element-wise to match dimensions of the layer output or concatenated to increase dimensionality. In other examples, the camera-specific positional embeddings may be learned during training utilizing one-hot encoding, such that all positions of a first camera-specific embedding are initialized to a value of zero (0) except for a first specified embedding and all positions of a second camera-specific embedding initialized to a value of one (1) except for a second specified embedding, and so forth for N embeddings. In other examples, learnable embeddings may be randomly initialized prior to training.

During inference time, processing circuitry may generate respective feature vectors from each of the multiple camera images with the shared image feature encoder using the camera-specific positional embeddings associated with different respective cameras used to capture the multiple camera images. Because the camera-specific positional embeddings used during training are each associated with one of the different respective cameras, the shared image feature encoder may leverage these embeddings to maintain camera-specific feature distinctions. For instance, use of the embeddings may allow a shared image feature encoder to be fine-tuned for specific cameras without using completely separate feature extractors. Processing circuitry may subsequently perform a perception task using the respective feature vectors. Processing circuitry may also project the features into a Bird's-Eye-View (BEV) grid space using a BEV network to enable useful downstream tasks. For instance, an advanced driver-assistance system (ADAS) may be configured to control a vehicle utilizing the output provided by the perception task(s) performed and/or utilizing the BEV grid space.

While aspects of the disclosure are generally described in relation to a four-camera system of a vehicle (e.g., a vehicle with front, rear, left, and right-facing cameras), an arbitrary set of N sensors may be utilized to capture the image data for a current time, including image data from sensors including LiDAR and/or radar.

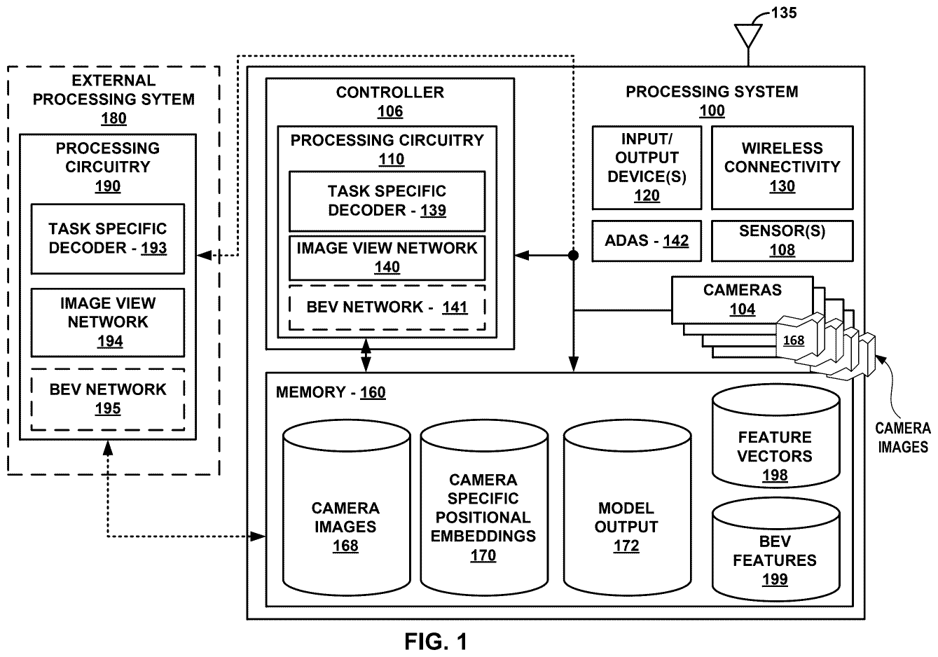

FIG. 1 is a block diagram illustrating an example processing system 100, in accordance with one to more techniques of this disclosure. Processing system 100 may be used in an apparatus, such as a vehicle, including an autonomous driving vehicle or an assisted driving vehicle (e.g., a vehicle having an advanced driver-assistance system (ADAS) or an “ego vehicle”). In such an example, processing system 100 may represent an ADAS. In other examples, processing system 100 may be used in robotic applications, virtual reality (VR) applications, or other kinds of applications that may include both a camera and a LiDAR system. The techniques of this disclosure are not limited to vehicular applications. The techniques of this disclosure may be applied by any system that processes camera images 168 and/or image data for use by subsequent downstream tasks.

Processing system 100 may include cameras 104, controller 106, one or more sensor(s) 108, input/output device(s) 120, wireless connectivity component 130, and memory 160. Cameras 104 may be any type of camera configured to capture video or image data in the environment around processing system 100 (e.g., around a vehicle). In some examples, processing system 100 may include multiple cameras 104 for a four-camera system arrangement which includes a front-facing camera, a rear-facing camera, a left-facing camera, and a right-facing camera. In other examples, processing system 100 obtains image data from multiple cameras 104 data from sensor(s) 108 including a Lidar sensor, a radar sensor, or both. Each of multiple cameras 104 may correspond, by way of example, to a front-facing camera (e.g., a front bumper camera, a front windshield camera, and/or a dashcam), a back-facing camera (e.g., a backup camera), side-facing cameras (e.g., cameras mounted in sideview mirrors). Cameras 104 may be a color camera or a grayscale camera. In some examples, cameras 104 may be a camera system including multiple cameras 104 and sensor(s) 108 as concurrent camera image 168 streams from each of the cameras and sensor(s) 108. A current camera image from each camera 104 for a current time may be derived from camera image 168 streams. Cameras 104 may, in some examples, be configured to collect camera images 168.

Wireless connectivity component 130 may include subcomponents, for example, for third generation (3G) connectivity, fourth generation (4G) connectivity (e.g., 4G Long Term Evolution (LTE)), fifth generation (5G) connectivity (e.g., 5G or New Radio (NR)), Wi-Fi connectivity, Bluetooth connectivity, and other wireless data transmission standards. Wireless connectivity component 130 is further connected to one or more antennas 135.

Processing system 100 may also include one or more input and/or output devices 120, such as screens, touch-sensitive surfaces (including touch-sensitive displays), physical buttons, speakers, microphones, and the like. Input/output device(s) 120 (e.g., which may include an I/O controller) may manage input and output signals for processing system 100. In some cases, input/output device(s) 120 may represent a physical connection or port to an external peripheral. In some cases, input/output device(s) 120 may utilize an operating system. In other cases, input/output device(s) 120 may represent or interact with a modem, a keyboard, a mouse, a touchscreen, or a similar device. In some cases, input/output device(s) 120 may be implemented as part of a processor (e.g., a processor of processing circuitry 110). In some cases, a user may interact with a device via input/output device(s) 120 or via hardware components controlled by input/output device(s) 120.

Controller 106 may be an autonomous or assisted driving controller (e.g., an ADAS) configured to control operation of processing system 100 (e.g., including the operation of a vehicle). For example, controller 106 may control acceleration, braking, and/or navigation of a vehicle through an environment surrounding the vehicle. Controller 106 may include one or more processors, e.g., processing circuitry 110. Controller 106 is not limited to controlling vehicles. Controller 106 may additionally or alternatively control any kind of controllable object, such as a robotic component. Processing circuitry 110 may include one or more central processing units (CPUs), such as single-core or multi-core CPUs, graphics processing units (GPUs), digital signal processor (DSPs), application specific integrated circuits (ASICs), field programmable gate arrays (FPGAs), neural processing unit (NPUs), multimedia processing units, and/or the like. Instructions applied by processing circuitry 110 may be loaded, for example, from memory 160 and may cause processing circuitry 110 to perform the operations attributed to processor(s) in this disclosure. In some examples, one or more of processing circuitry 110 may be based on an Advanced Reduced Instruction Set Computer (RISC) Machine (ARM) or a RISC five (RISC-V) instruction set.

An NPU is generally a specialized circuit configured for implementing control and arithmetic logic for executing machine learning algorithms, such as algorithms for processing artificial neural networks (ANNs), deep neural networks (DNNs), random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

Processing circuitry 110 may also include one or more sensor processing units associated with cameras 104, and/or sensor(s) 108. For example, processing circuitry 110 may include one or more image signal processors associated with cameras 104 and/or sensor(s) 108, and/or a navigation processor associated with sensor(s) 108, which may include satellite-based positioning system components (e.g., Global Positioning System (GPS) or Global Navigation Satellite System (GLONASS)) as well as inertial positioning system components. In some aspects, sensor(s) 108 may include direct depth sensing sensors, which may function to determine a depth of or distance to objects within the environment surrounding processing system 100 (e.g., the environment surrounding a vehicle).

Processing system 100 also includes memory 160, which is representative of one or more static and/or dynamic memories, such as a dynamic random-access memory, a flash-based static memory, and the like. In this example, memory 160 includes computer-executable components, which may be applied by one or more of the aforementioned components of processing system 100.

Examples of memory 160 include random access memory (RAM), read-only memory (ROM), electrically erasable programmable ROM (EEPROM), compact disk ROM (CD-ROM), or another kind of hard disk. Examples of memory 160 include solid state memory and a hard disk drive. In some examples, memory 160 is used to store computer-readable, computer-executable software including instructions that, when applied, cause a processor to perform various functions described herein. In some cases, memory 160 contains, among other things, a basic input/output system (BIOS) which controls basic hardware or software operation such as the interaction with peripheral components or devices. In some cases, a memory controller operates memory cells. For example, the memory controller may include a row decoder, column decoder, or both. In some cases, memory cells within memory 160 store information in the form of a logical state.

Processing system 100 may be configured to perform techniques for obtaining camera images 168 from multiple cameras 104 of processing system 100 and applying image view network 140 to camera images 168 at inference time utilizing camera-specific positional embeddings 170 used to train image view network 140. Camera-specific positional embeddings 170 may be in the form of fixed-length numerical representations of input data that encode patterns or relationships unique to the respective camera images 168. Camera-specific positional embeddings 170 may serve as compressed feature representations that enable image view network 140 to systematically interpret and process various types of inputs more effectively. For instance, image view network 140 may perform extraction of feature vectors 198 differently based on the distinct characteristics associated with each of the multiple cameras 104 using camera-specific positional embeddings 170 used to train image view network 140, when such embeddings are provided as input to image view network 140 during inference time.

Additional processing may be applied to process extracted feature vectors 198, for instance, to perform a perception task utilizing feature vectors 198. In other examples, additional processing may be applied to transform extracted feature vectors 198 into BEV features 199 or to project extracted feature vectors 198 into, for example, a BEV grid space by a BEV network. For instance, image view network 140, 194 may apply post-processing operations to perform perception tasks utilizing extracted feature vectors 198. Once feature vectors 198 are extracted by image view network 140, 194, they may be transformed into a Birds-Eye-View (BEV) space by BEV network 141. This transformation involves projecting extracted feature vectors 198 from their original perspective representation into a top-down view, aligning them spatially in a unified BEV feature map. Projection operations may utilize distinct characteristics learned for each of the multiple cameras 104, including geometric and positional relationships of the cameras 104 in relation to a scene. Utilizing such projection operations, BEV network 141 may generate BEV features 199 providing an integrated representation of a scene from the multiple processed camera images 168 to enable subsequent downstream tasks, such as path planning for autonomous systems.

Image view network 140 may be implemented in software, firmware, and/or any combination of hardware described herein. Image view network 140 may be configured to receive or obtain camera images 168 captured by cameras 104. Image view network 140 may be configured to write model output 172 into memory 160. In some examples, the plurality of camera images 168 may be referred to herein as “image data.” Moreover, camera images 168 may include static images, video imagery, a video stream, LiDAR data, radar data, or some combination thereof from multiple cameras 104 and sensor(s) 108.

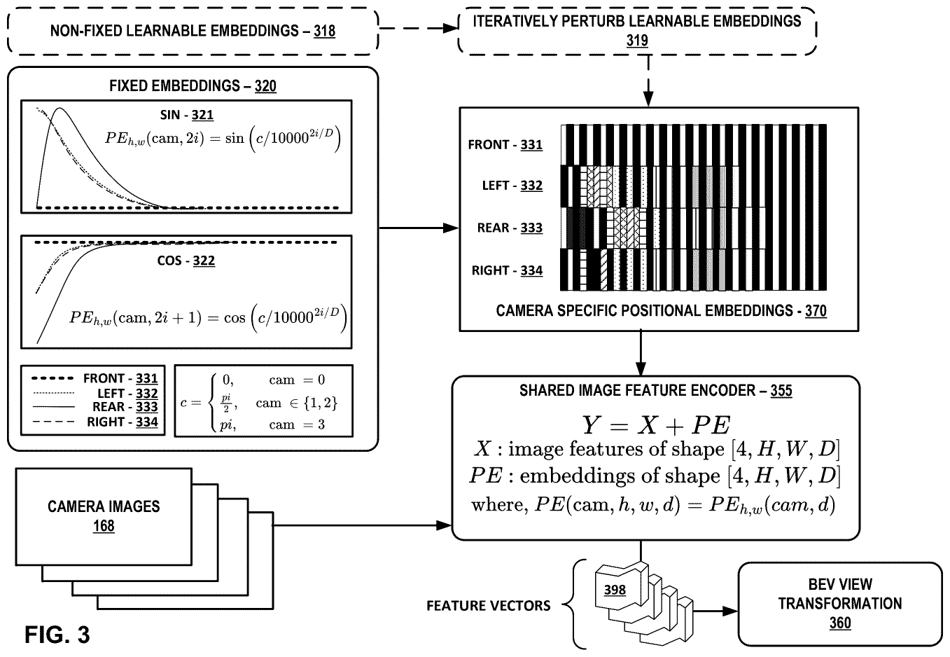

Image view network 140, 194 may also extract features vectors from raw sensor data from sensor(s) 108 and/or camera images 168 captured by cameras 104, by employing neural networks or similar architectures to detect patterns such as edges, textures, and object shapes. These networks specialize in processing the perspective view, leveraging hierarchical feature extraction where lower layers identify simple patterns and deeper layers capture complex structures and relationships in a scene. Feature extraction may be tailored to camera-specific positional embeddings 370 (see FIG. 3) during inference time based on camera-specific positional embeddings 170 provided as input to image view network 140, 194 at inference time for processing camera images 168.

In some examples, processing circuitry 110 may be configured to train one or more machine learning models such as encoders, decoders, positional encoding models, or any combination thereof applied by image view network 140, 194 using training data. Training data includes camera-specific positional embeddings 170 with each respective camera 104 having their own corresponding embedding.

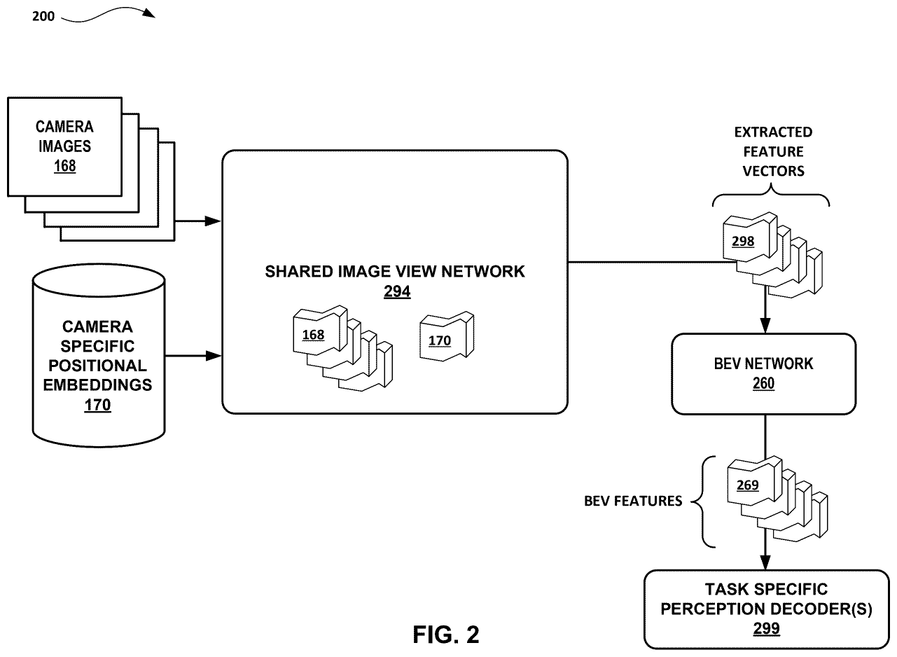

Processing circuitry 110 of controller 106 may apply ADAS 142 to control an object (e.g., a vehicle, a robotic arm, or another object that is controllable based on the output from image view network 140, 194) corresponding to processing system 100 and external processing system 180, respectively. ADAS 142 may control the object in coordination with controller 106 or ADAS 142 may operate independently and separate from controller 106. ADAS 142 may control the object based on information included in the output generated by image view network 140, 194 relating to one or more objects within a 3D space including processing system 100. For example, output generated by image view network 140, 194 may include feature vectors 198, object segmentation information, or other feature information such as pixel classifications, classifications for regions of an image, an identity of one or more objects, a position of one or more objects relative to the processing system 100, characteristics of movement (e.g., speed, acceleration) of one or more objects, or any combination thereof. Based on this information, ADAS 142 may control the object corresponding to processing system 100. In other examples, task specific perception decoder(s) 299 (see FIG. 2) may generate other feature information from extracted feature vectors 198 provided as output by image view network 194. The output from image view network 140, 194 may be stored in memory 160 as model output 172.

In the context of computer vision, an optional BEV network 141 enables processing of multiple current camera images 168 obtained at a single point in time. In such an example, BEV network 141 may transform the multiple camera images 168 into a unified top-down view, referred to as a BEV view, as if looking at a scene from above. A BEV view may enable downstream tasks, such as controlling a vehicle via autonomous driving applications or manipulating an object, such as utilizing robotics control applications.

In examples utilizing an optional BEV network 141, multiple camera images 168 (e.g., from multiple cameras and/or multiple sensors of a subject vehicle) are obtained and processed corresponding to a single point in time. A collection of such camera images 168 (e.g., current camera images 168) may represent a current time or a single point in time. Subsequent to generation of a BEV image space, task specific decoder 139, 193 processes encoded features to generate outputs tailored to a specific task, such as object detection, segmentation, lane recognition, etc.

For example, processing system 100 configured with optional BEV network 141 may generate a BEV view from multiple camera images 168 originating from multiple sensors or cameras (such as front, side, and rear cameras in vehicles), each captured from different angles. In such an example, camera images 168 are then geometrically transformed using perspective correction, warping, and stitching techniques to align them into a single top-down map. The transformation typically involves projecting the camera's 2D perspective into a common ground plane, using the known geometry of the cameras and the environment. BEV network 141 then fuses these images to create a complete 360-degree BEV view around the subject vehicle. This allows for easier detection of objects (such as lane markings, cars, pedestrians, or obstacles) because the spatial relationships between objects can be better understood from a bird's-eye perspective.

In some examples, image view network 140 may optionally be configured to operate in conjunction within image view network 194 of external processing system 180 to offload computational burdens from image view network 140 and processing circuitry 110. External processing system 180 may include processing circuitry 190, which may be any of the types of processors described above for processing circuitry 110. Processing circuitry 190 may include task specific decoder 193, image view network 194, and BEV network 195. Processing circuitry 190 may acquire camera images 168 from cameras 104, respectively, or from memory 160. Though not shown, external processing system 180 may also include a memory that may be configured to store camera images, model outputs, fixed embeddings, learned embeddings, feature vectors, among other data that may be used in data processing. Processing circuitry 190 may be configured to perform any of the techniques described as being performed by the processing circuitry 110 and its sub-components including task specific decoder 193, image view network 194, and BEV network 195. ADAS 142 may be configured to operate at the direction of external processing system 180 or may be configured to instruct external processing system 180 to perform operations associated with task specific decoder 193, image view network 194, and BEV network 195.

FIG. 2 is a block diagram illustrating an architecture for processing camera images 168 from multiple distinct cameras through shared image view network 294 to generate extracted feature vectors 198 based on camera-specific positional embeddings 170 used to train shared image view network 294, in accordance with one or more techniques of this disclosure. FIG. 2 depicts camera images 168 and camera-specific positional embeddings 170 provided to shared image view network 294. As will be described in more detail below, camera-specific positional embeddings 170 may be fixed for each of the cameras, or camera-specific positional embeddings 170 may be learned during training. That is, in some examples, camera-specific positional embeddings 170 may be iteratively updated, along with the weights and parameters of shared image view network 294, during a training process. Shared image view network 294 receives as input, both camera images 168 and camera-specific positional embeddings 170 to generate extracted feature vectors 298. For instance, shared image view network 294 may generate extracted feature vectors 298 based on the distinct characteristics learned for each of the multiple cameras 104 based on the camera-specific positional embeddings 170 used during training.

In a transformer encoder, positional embeddings are added to the input to provide information about the order of tokens, since the self-attention mechanism itself is inherently order-agnostic. From a high level, such a process may include operations such as token embedding, positional embedding, summation, and processing of the inputs using the encoder. Each token in the input sequence is first converted into a dense vector representation using an embedding layer through token embedding. Positional embedding follows, where a fixed or learned positional encoding is generated to represent the position of each token in the sequence, which can be achieved using predefined sinusoidal functions (as in the original Transformer) or learned embeddings. The positional embeddings are then added element-wise to the token embeddings in the summation step, producing a combined representation that retains both semantic meaning and positional information. The resulting input embeddings, including both (token+positional) embeddings, are subsequently provided as input into the transformer encoder layers, where self-attention and feedforward networks process the sequence. The addition of positional embeddings enables the model to capture positional dependencies, even though the self-attention mechanism does not inherently consider order.

Shared image view network 294 may be configured to utilize a distinct embedding for each of the multiple distinct cameras, such that all of the embeddings are camera-specific. Alternatively, shared image view network 294 may be configured to use distinct embeddings for some of the multiple distinct cameras and use different but common embedding for some of the cameras, such that at least some portion of the multiple distinct cameras share an embedding while other cameras utilize a different and distinct embedding. Consider, for example, a four-camera configuration for a vehicle, with a front-facing camera, a rear-facing camera, a left-facing camera, and a right-facing camera. In one configuration, each of the four cameras may be configured to utilize a distinct camera-specific positional embedding, such that all of the embeddings are different. In another configuration, the front-facing camera and the rear-facing camera may be configured to each utilize distinct embeddings, while the left-facing camera and the right-facing camera share the same embedding which is distinct from both the embedding used for the front-facing camera and the embedding used for the rear-facing camera.

Extracted feature vectors 298 are provided to BEV network 260 for projection into a BEV image space. BEV network 260 creates BEV features 269, which are projected into BEV image space. These BEV features 269, having been transformed into the BEV space, are then provided to multiple task-specific perception decoders 299, each designed to perform decoding for a specific downstream task. For instance, some task-specific decoders may include object detection, which identifies and classifies vehicles, pedestrians, or other obstacles; image segmentation, which partitions the scene into distinct regions for further analysis; traffic light recognition, which detects and interprets traffic signals; and lane marking detection, which identifies lane boundaries and road markings.

The task-specific decoders operate independently but in parallel, each dedicated to extracting meaningful insights from BEV features 269 for their respective decoding tasks. Some decoders focus on identifying and classifying objects in the scene, while others extract lane topology or traffic control information, enabling a variety of perception tasks to be handled simultaneously.

Subsequent to task-specific decoding, useful downstream tasks may consume the output of the decoders, such as ADAS 142, which utilizes the results from these decoders to execute real-time driving functions, enhancing safety and automation. Additionally, other downstream systems beyond ADAS 142 may utilize BEV features 269, such as an infotainment system that displays a BEV-type image to a backup camera, providing the driver with a top-down visualization of their surroundings.

This flow follows a structured process where sensor data is first captured, followed by feature extraction using camera-specific embeddings. The extracted features undergo a BEV transformation to generate BEV features 269, which are then processed by the multiple task-specific decoders, each specializing in distinct aspects of scene interpretation. Subsequent downstream functions, such as ADAS 142, integrate the decoded outputs to enable vehicle control functions, increase situational awareness, improve safety, and task automation.

According to a particular example, task specific perception decoder(s) 299 are configured to perform one or more perception tasks which are selected from a group that includes: performing lane detection and tracking using the respective extracted feature vectors 298; performing traffic sign recognition using the respective extracted feature vectors 298; performing traffic light recognition using the respective extracted feature vectors 298; performing pedestrian detection using the respective extracted feature vectors 298; performing vehicle detection using the respective extracted feature vectors 298; performing road surface detection using the respective extracted feature vectors 298; performing crosswalk detection using the respective extracted feature vectors 298; or performing road hazard detection using the respective extracted feature vectors 298.

Embeddings are associated with the cameras, making them explicitly camera-specific. Since the shared image view network 294 is trained using camera-specific embeddings, performance of shared image view network 294 will vary slightly when processing images from different cameras, as the same embeddings-additional data included in the input—are utilized during inference. Consequently, shared image view network 294 generates feature vectors 298 that are more tailored to the specific camera providing the input, eliminating the need for separate image view networks allocated to each camera. This approach allows the output feature vectors to more accurately capture variations in brightness, intensity, contrast, position, and occlusion unique to each camera without requiring distinct models. While shared image view network 294 does not perform any transformation on the feature vectors, the generated feature vectors may differ slightly for each camera due to the use of different embeddings.

As depicted by FIG. 2, there are multiple distinct camera images 168 processed through shared image view network 294. According to at least one example, shared image view network 294 generates respective feature vectors from each of the multiple camera images 168 associated with each of a front-facing camera, a rear-facing camera, a left-facing camera, and a right-facing camera of a vehicle using the camera-specific positional embeddings 170 associated with the different respective cameras 104 (see FIG. 1) used to capture the multiple camera images 168.

Shared image view network 294 may be configured to apply fixed camera-specific positional embeddings 170 at inference time. Alternatively, shared image view network 294 may be configured using non-fixed learnable camera-specific positional embeddings 170 during a training phase to create fixed camera-specific positional embeddings 170 which are applied inference time. In either case, the camera-specific positional embeddings 170 will be fixed and known at inference time, regardless of whether it was derived during a training phase from a fixed embedding or a learnable non-fixed embedding.

A fixed embedding refers to a predefined, manually assigned vector that remains unchanged during training, whereas a non-fixed learnable embedding is optimized through the training process, allowing shared image view network 294 to develop distinct feature representations for different cameras based on observed data. According to this approach, shared image view network 294 may learn distinct camera-specific positional embeddings 170 for each of the front-facing camera, rear-facing camera, left-facing camera, and right-facing camera during training if non-fixed learnable embeddings are used. Alternatively, fixed embeddings can be manually assigned and remain unchanged throughout the model training phase.

When processing an image at inference time, the corresponding camera-specific positional embeddings 170 is selected and incorporated into shared image view network 294, enabling shared image view network 294 to be tuned to the specific characteristics of a given camera. Camera-specific positional embeddings 170 can be added at the input level during inference time for processing camera images 168. In other examples, camera-specific positional embeddings 170 may be added at an intermediate layer within shared image view network 294, influencing feature extraction at various stages of the processing pipeline. Shared image view network 294 subsequently outputs the extracted feature vectors from the current set of multiple camera images 168. In some examples, shared image view network 294 may optionally include a label indicating the source camera, such as the front-facing, rear-facing, left-facing, or right-facing camera of the vehicle.

Since architecture 200 may be integrated into ADAS 142 for vehicle control, output from shared image view network 294 and BEV network 260 can enable ADAS 142 (FIG. 1) to control the vehicle based on a representation of predicted objects and their extracted feature vectors 298. As described in greater detail above, task-specific decoders independently process BEV features 269 to perform distinct perception tasks, including object detection to identify and classify vehicles, pedestrians, and obstacles; image segmentation to partition the scene into meaningful regions; traffic light recognition to detect and interpret signals; and lane marking detection to identify lane boundaries and road markings. These decoders operate in parallel, with some focused on detecting and classifying objects, while others extract lane topology or traffic control information, enabling multiple perception tasks to be processed simultaneously. Architecture 200 (FIG. 2) may be configured to control a vehicle using extracted feature vectors 298 and BEV features 269. For example, architecture 200 (FIG. 2) may utilize processing circuitry 110 and memory 160 (FIG. 1) as part of an advanced driver assistance system (ADAS) to facilitate vehicle control.

Architecture 200 may use machine learning models, including shared image view network 294 and models utilizing, for example, convolutional neural network (CNN) layers, to analyze the input data in a hierarchical manner. The CNN layers may apply filters to capture local patterns and gradually combine them to form higher-level features. Shared image view network 294 may operate in conjunction with convolutional layers of shared image view network 294 to extract increasingly complex visual representations from camera images 168 based at least in part on distinct characteristics learned for each of the multiple cameras 104 which are known to shared image view network 294 based on camera-specific positional embeddings 170.

During training, architecture 200 may be trained using a loss function that measures the discrepancy between multiple camera images 168 and ground truth images as well as ground truth data, which may include information such as the source camera for each of the multiple camera images 168. This loss function guides the learning process, encouraging the encoder to extract meaningful features and the decoder to generate more accurate reconstructions. The training process seeks to minimize the difference between the generated output and the ground truth information, typically employing backpropagation and gradient descent techniques to iteratively refine the model.

To facilitate camera-specific adaptation, a camera-specific embedding is applied to the input for each camera during training. A distinct embedding is used for each camera, allowing the shared model to learn differentiated feature representations for images captured from different viewpoints. As noted above, in some alternative configurations, a distinct embedding is used for some of the cameras, such as the front-facing camera and the rear-facing camera, while the same embedding may be used for both the left and right-facing cameras, albeit with a different embedding than either of the front or rear-facing cameras.

The optimization process may include updating the weights and parameters of shared image view network 294 throughout training. In one example, the embeddings for each camera remain fixed, and only the weights and parameters of the image view network are updated during each iteration, ensuring that the network adapts while preserving pre-defined camera-specific representations. In other examples, both the camera-specific embeddings and the weights and parameters of shared image view network 294 are updated during each iteration, allowing the embeddings themselves to be refined over time alongside the rest of the model. However, even when non-fixed learnable embeddings are refined during the training process, they become fixed at the end of the training process, thus providing camera-specific positional embeddings 170 which are fixed for use during inference time. Such a training strategy enables shared image view network 294 to learn to process images from different cameras while maintaining adaptability to camera-specific characteristics, ultimately enhancing feature extraction and scene interpretation.

FIG. 3 is a conceptual diagram for generating camera-specific positional embeddings 170 for a shared image feature encoder 355 from a set of fixed embeddings 320, in accordance with one or more techniques of this disclosure. Optionally, non-fixed learnable embeddings 318 may be utilized, in which processing circuitry iteratively perturbs learnable embeddings 319 during a training phase to determine the camera-specific positional embeddings 370.

As depicted in FIG. 3, the set of fixed embeddings 320 includes both SIN 321 (sine) and COS 322 (cosine) functions. These positional embeddings are generated using alternating sine and cosine functions, resulting in the striped pattern observed in element 350. The SIN 321 function is defined as:

$${PE}_{h , w} ( cam , 2 i ) = sin ( c / {10000}^{2 i / D} ) ,$$

while the COS 322 function is defined as:

$${PE}_{h , w} ( cam , 2 i + 1 ) = sin ( c / {10000}^{2 i / D} ) ,$$

where c is a frequency factor assigned based on the camera index. Specifically, the FRONT camera is assigned cam=0, the LEFT camera cam=1, the RIGHT camera cam=2, and the REAR camera cam=3. Since the LEFT and RIGHT cameras share the same frequency factor c, their positional embeddings are identical.

Each positional embedding vector PE_{h,w}(cam, d) consists of D elements, where d=0, . . . , D−1. The first element of the vector, PE_{h,w}(cam, 0), is computed using the sine function, while the second element, PE_{h,w}(cam, 1), is computed using the cosine function. This alternation continues throughout the vector, with the function frequency i increasing proportionally to d. Consequently, the final two elements of the positional embedding vector, PE_{h,w}(cam, D−2) and PE_{h,w}(cam, D−1), are derived from the sine and cosine functions at much higher frequencies. For Row 1 (FRONT 331), where c=0, the resulting positional embedding consists of alternating 0s and 1s, as evident in the function plots for FRONT 331, where the sine function remains constantly 0 and the cosine function remains constantly 1. For Row 2 (LEFT 332), the positional embedding vector PE_{h,w}(1, d) is generated using c=π/2, resulting in a different pattern that reflects the increased frequency i as d increases. Similarly, Row 3 (REAR 333) is generated with c=π, further altering the sinusoidal encoding pattern. Row 4 (RIGHT 334) is generated with c=π/2, making its positional embeddings identical to those of LEFT 332 in this example. Since both LEFT and RIGHT cameras share the same frequency factor, their positional embeddings are identical.

In a manner similar to how transformer networks utilize positional embeddings to counteract positional invariance, these camera-specific positional embeddings 370 may be either added element-wise or concatenated along the depth dimension to the input or output of a network layer within the shared image encoder 355. In the case of concatenation, the resulting tensor Y may have dimensions [4, H, W, 2D], or more generally [4, H, W, D1+D2], where D1 is the number of channels of the input features and D2 is the number of channels in the positional embeddings, allowing for flexibility in their respective dimensions. Alongside processing camera images 168, these embeddings enable the shared image encoder 355 to adapt to each source camera 104 (see FIG. 2) and extract features tailored to the unique characteristics of the training data. An intuitive, albeit simplified, interpretation of this structure is that it resembles a binary encoding scheme, where Row 1 (FRONT 331) corresponds to 000 . . . (i.e., 0), Row 2 (LEFT 332) corresponds to 100 . . . (i.e., 1), Row 3 (REAR 333) corresponds to 010 . . . (i.e., 2), and Row 4 (RIGHT 334) corresponds to 100 . . . (i.e., 1). However, instead of a strict binary representation, alternating sinusoidal functions may be used to fully leverage the available floating-point precision. As illustrated in FIG. 3, these sinusoidal positional embeddings are applied within the shared image feature encoder 355 using an addition (+) operation.

As depicted here, the equation Y=X+PE describes a process of enhancing image features X by adding positional information PE. Here, X represents the image features extracted from the input images and has a shape of [4, H, W, D], where 4 corresponds to the number of cameras from which the multiple camera images 168 were sourced or originated. The terms H and W denote the height and width of the feature map, and D represents the feature dimensionality (depth or number of channels). The PE term denotes positional embeddings, which also have a shape of [4, H, W, D] to encode spatial and/or camera-specific information. The addition operation (+) indicates that positional embeddings are added element-wise to feature vectors 398 extracted from the camera images 168. More specifically, PE (cam, h, w, d)=PE_{h,w}(cam, d) shows that camera-specific positional embeddings 170 depend on the camera index (cam) and the feature channel or depth (d), and are broadcasted over all spatial locations in the feature map (h, w). This means that for each camera, a unique positional encoding vector is added across all spatial locations to the corresponding feature vectors 398 as extracted from camera images 168.

This approach is useful in the context of computer vision, as it enhances the ability of shared image feature encoder 355 to differentiate between features based on their spatial positions and viewpoints which are distinct for each of the variously sourced camera images 168. Computer vision tasks, especially those involving multi-camera setups (such as autonomous driving or 360-degree perception), benefit from the ability to interpret spatial information, thus providing a type of systematic spatial awareness, to effectively interpret features captured from different viewpoints corresponding to the different source cameras. Positional embeddings enable this spatial awareness by encoding relative positional and camera-specific information directly into the feature representations.

Shared image feature encoder 355 then provides output, such as feature vectors 398 to BEV view transformation 360 for subsequent downstream processing. Feature vectors 398 are numerical representations of various characteristics extracted from camera images 169. Feature vectors 398 may encode visual information such as edges, textures, colors, shapes, and spatial relationships in a structured format that downstream models, such as BEV view transformation 260 type models, can process efficiently. In self-driving systems, feature vectors 398 enable downstream systems to systematically interpret a scene captured by the cameras 104 (see FIG. 1) by representing objects, road markings, pedestrians, and other elements detected within the camera images 168.

Feature vectors 398 may enable downstream tasks, such as BEV view transformation 360 and/or task specific perception decoder(s) 299 (see FIG. 2) to recognize patterns, make predictions, and react in real time, enabling safer and more accurate decision-making in autonomous navigation. Feature vectors 398 may be utilized for downstream tasks including lane detection, obstacle avoidance, and trajectory planning.

Processing circuitry 110 (see FIG. 1) may be configured to train shared image feature encoder 355 using fixed embeddings 320 to create fixed camera-specific positional embeddings 370 associated with different respective cameras for use at inference time. When using fixed embeddings 320, training shared image feature encoder 355 does not involve learning the camera-specific positional embeddings themselves; instead, fixed camera-specific positional embeddings 370 are pre-defined and applied at various layers of the encoder to guide the feature extraction process. The training process includes inputting fixed camera-specific positional embeddings 370, where each embedding consists of a predefined sinusoidal representation unique to each respective camera. These embeddings are not updated during training but serve as additional information to help the shared image feature encoder 355 learn to extract camera-specific features. The length of each fixed camera-specific positional embedding 370 may vary depending on the layer at which it is incorporated, as it may be added or concatenated with the output from different layers of shared image feature encoder 355.

In alternative examples, processing circuitry 110 (see FIG. 1) may be configured to train shared image feature encoder 355 using non-fixed learnable embeddings to create fixed camera-specific positional embeddings 370 associated with different respective cameras for use at inference time. In this case, rather than utilizing predefined embeddings during the training phase, the camera-specific positional embeddings 370 are initialized and then updated as part of the training process. The model learns to refine non-fixed learnable embeddings 318 over multiple training iterations during the training process to better capture the distinct characteristics of images from each camera.

For example, during training, a unique camera-specific embedding is assigned to each camera, but unlike fixed embeddings 320, non-fixed learnable embeddings 318 are updated along with the weights and parameters of shared image feature encoder 355. The loss function used during training encourages the embeddings to evolve in a way that enhances the encoder's ability to extract useful camera-specific features. This approach allows non-fixed learnable embeddings 318 to be dynamically adapted, during the training phase, based on learned relationships between input images and ground truth data. As a result, at inference time, camera-specific positional embeddings 370 derived from non-fixed learnable embeddings 318 serve the same purpose as camera-specific positional embeddings 370 derived from fixed embeddings 320, but offer greater flexibility, albeit at greater computational training costs, as they have been optimized during the training phase based on the training data rather than being manually predefined.

Other techniques may be utilized to create learnable embeddings 318 other than use of a set of sinusoids. For instance, one-hot techniques or random initialization may be utilized. According to one example, processing circuitry 110 generates camera-specific positional embeddings 370 for each of multiple cameras of a vehicle using one-hot encoding with all positions of a first camera-specific embedding initialized to a value of zero (0) except for a first specified embedding and with all positions of a second camera-specific embedding initialized to a value of one (1) except for a second specified embedding. Additional embeddings from two (2) through N may be configured similarly. In other examples, each of multiple embeddings may be randomly initialized and iteratively updated with learned embeddings during training.

In a particular example, processing circuitry 110 (see FIG. 1) may be configured to train shared image feature encoder 355 using camera-specific positional embeddings 370 associated with the different respective cameras. The training process may use non-fixed learnable embeddings 318 and/or learnable camera-specific positional embeddings which are not known, a priori. For instance, training shared image feature encoder 355 with camera-specific positional embeddings 370 may include initializing non-fixed learnable embeddings 318 and/or learnable camera-specific positional embeddings using one-hot encoding with all positions of a first camera-specific positional embedding initialized to a value of zero (0) except for a first specified embedding and with all positions of a second camera-specific positional embedding initialized to a value of one (1) except for a second specified embedding. The same process may be utilized for third and fourth cameras in a 4-camera configuration as well as LiDAR and RADAR sensor data when available. Processing circuitry 110 (see FIG. 1) may iteratively perturb learnable embeddings 319 to determine which embeddings satisfy a threshold condition, at which point the learned embeddings may be fixed as camera specific positional embeddings 370 for subsequent use during inference time. For example, processing circuitry 110 (see FIG. 1) may iteratively modify the values of the first camera-specific positional embedding and the values of the first camera-specific positional embedding to reduce computed losses using the first camera-specific positional embedding and the second camera-specific positional embedding after each iterative modification when compared with a ground truth.

According to another example, training shared image feature encoder 355 using camera-specific positional embeddings 370 includes initializing non-fixed learnable embeddings 318 and/or learnable camera-specific positional embeddings using random initialization of values of non-fixed learnable embeddings 318 and/or learnable camera-specific positional embeddings and iteratively modifying the values of non-fixed learnable embeddings 318 and/or learnable camera-specific positional embeddings to reduce losses computed after each iterative modification when compared with a ground truth.

According to yet another example, training shared image feature encoder 355 using camera-specific positional embeddings 370 includes back-propagating the learned camera-specific positional embeddings 370 associated with the different respective cameras during training; perturbing weights of the shared image feature encoder 355 based on camera-specific positional embeddings 370 associated with the different respective cameras learned during a prior training epoch; and re-learning the camera-specific positional embeddings associated with the different respective cameras using the perturbed weights of the shared image feature encoder.

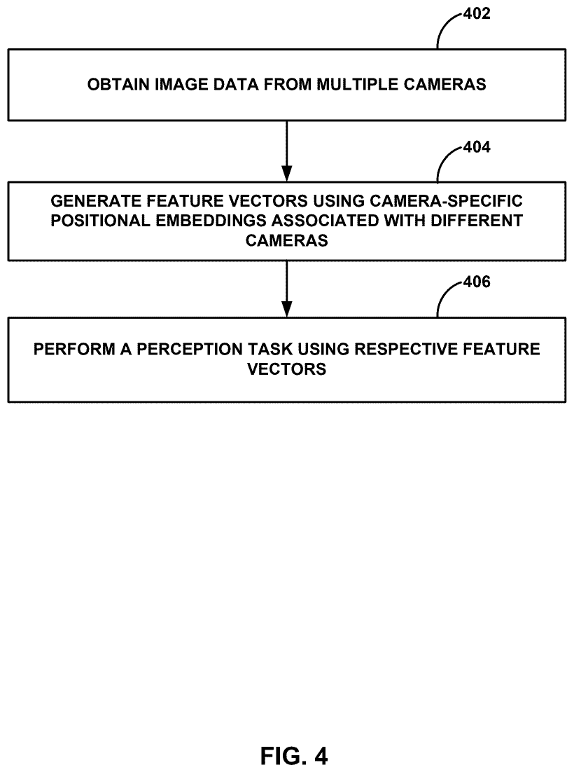

FIG. 4 is a flow diagram illustrating an example method for processing image data from multiple cameras, in accordance with one or more techniques of this disclosure. FIG. 4 is described with respect to processing system 100 and external processing system 180 of FIG. 1, architecture 200 of FIG. 2, and the techniques discussed in relation to FIG. 3. However, the techniques of FIG. 4 may be performed by different components of processing system 100, external processing system 180, architecture 200, or by additional or alternative systems.

Processing circuitry 110 may be configured to obtain image data from multiple cameras (402). For example, processing circuitry 110 may be configured to obtain the image data including a current set of multiple camera images 168 from multiple cameras 104.

According to such an example, processing circuitry 110 may be configured to generate feature vectors 198 using camera-specific positional embeddings 170 associated with different cameras 104 (404). For instance, processing circuitry 110 may be configured to generate respective feature vectors 198 from each of the multiple camera images 104 with a shared image feature encoder 355 using camera-specific positional embeddings 170 associated with different respective cameras 104 used to capture the multiple camera images 168.

According to such an example, processing circuitry 110 may be configured to perform a perception task using respective feature vectors 198 (406).

In other examples, processing circuitry 110 is configured to generate birds-eye-view (BEV) features from the respective feature vectors and process the BEV features using a task-specific perception decoder to perform the perception task.

Additional aspects of the disclosure are detailed in numbered clauses below.

Clause 1—An apparatus for processing image data, the apparatus comprising: a memory for storing the image data; and processing circuitry in communication with the memory, wherein the processing circuitry is configured to: obtain the image data including a current set of multiple camera images from multiple cameras; generate respective feature vectors from each of the multiple camera images with a shared image feature encoder using camera-specific positional embeddings associated with different respective cameras used to capture the multiple camera images; and perform a perception task using the respective feature vectors.

Clause 2—The apparatus of clause 1, wherein to perform the perception task using the respective feature vectors, the processing circuitry is further configured to: generate birds-eye-view (BEV) features from the respective feature vectors; and process the BEV features using a task-specific perception decoder to perform the perception task.

Clause 3—The apparatus of clause 1 or 2, wherein the processing circuitry is further configured to: train the shared image feature encoder with the camera-specific positional embeddings associated with the different respective cameras, wherein the camera-specific positional embeddings are fixed.

Clause 4—The apparatus of clause 3, wherein to train the shared image feature encoder with the camera-specific positional embeddings, the processing circuitry is further configured to: input the fixed camera-specific positional embeddings having a respective sinusoid for each of the different respective cameras, wherein a length of each of the fixed camera-specific positional embeddings varies according to which layer of the shared image feature encoder each of the fixed camera-specific positional embeddings are added or concatenated with output from the respective layer of the shared image feature encoder.

Clause 5—The apparatus of any of clauses 1-4, wherein the processing circuitry is further configured to: train the shared image feature encoder with learnable camera-specific positional embeddings.

Clause 6—The apparatus of clause 5, wherein to train the shared image feature encoder with the learnable camera-specific positional embeddings, the processing circuitry is further configured to: initialize the learnable camera-specific positional embeddings using one-hot encoding with all positions of a first camera-specific positional embedding initialized to a value of zero (0) except for a first specified embedding and with all positions of a second camera-specific positional embedding initialized to a value of one (1) except for a second specified embedding; and iteratively modify the values of the first camera-specific positional embedding and the values of the first camera-specific positional embedding to reduce computed losses using the first camera-specific positional embedding and the second camera-specific positional embedding after each iterative modification when compared with a ground truth.

Clause 7—The apparatus of clause 5, wherein to train the shared image feature encoder with the learnable camera-specific positional embeddings, the processing circuitry is further configured to: initialize the learnable camera-specific positional embeddings using random initialization of values of the learnable camera-specific positional embeddings; and iteratively modify the values of the learnable camera-specific positional embeddings to reduce losses computed after each iterative modification when compared with a ground truth.

Clause 8—The apparatus of clause 5, wherein to train the shared image feature encoder with the learnable camera-specific positional embeddings, the processing circuitry is further configured to: back-propagate the learned camera-specific positional embeddings associated with the different respective cameras during training; perturb weights of the shared image feature encoder based on the learnable camera-specific positional embeddings associated with the different respective cameras learned during a prior training epoch; and re-learn the learnable camera-specific positional embeddings associated with the different respective cameras using the perturbed weights of the shared image feature encoder.

Clause 9—The apparatus of any of clauses 1-8, wherein to generate the respective feature vectors from each of the multiple camera images, the processing circuitry is further configured to: generate one respective feature vector from each of the multiple camera images associated with each of a front-facing camera, a rear-facing camera, a left-facing camera, and a right-facing camera of a vehicle using the camera-specific positional embeddings associated with the different respective cameras used to capture the multiple camera images.

Clause 10—The apparatus of any of clauses 1-9, wherein to perform the perception task using the respective feature vectors, the processing circuitry is further configured to perform one or more perception tasks selected from a group comprising: lane detection and tracking using the respective feature vectors; traffic sign recognition using the respective feature vectors; traffic light recognition using the respective feature vectors; pedestrian detection using the respective feature vectors; vehicle detection using the respective feature vectors; road surface detection using the respective feature vectors; crosswalk detection using the respective feature vectors; or road hazard detection using the respective feature vectors.

Clause 11—The apparatus of any of clauses 1-10, wherein the processing circuitry is further configured to: control a vehicle using an output of the perception task.

Clause 12—The apparatus of any of clauses 1-11, wherein the processing circuitry and the memory are part of an advanced driver assistance system (ADAS).

Clause 13—A method of processing image data comprising: obtaining image data including a current set of multiple camera images from multiple cameras; generating respective feature vectors from each of the multiple camera images with a shared image feature encoder using camera-specific positional embeddings associated with different respective cameras used to capture the multiple camera images; and performing a perception task using the respective feature vectors.

Clause 14—The method of clause 13, wherein performing the perception task using the respective feature vectors, further comprises: generating birds-eye-view (BEV) features from the respective feature vectors; and processing the BEV features using a task-specific perception decoder to perform the perception task.

Clause 15—The method of clause 13 or 14, further comprising: training the shared image feature encoder with the camera-specific positional embeddings associated with the different respective cameras, wherein the camera-specific positional embeddings are fixed.

Clause 16—The method of any of clauses 13-15, wherein to training the shared image feature encoder with the camera-specific positional embeddings, further comprises: inputting the fixed camera-specific positional embeddings having a respective sinusoid for each of the different respective cameras, wherein a length of each of the fixed camera-specific positional embeddings varies according to which layer of the shared image feature encoder each of the fixed camera-specific positional embeddings are added or concatenated with output from the respective layer of the shared image feature encoder.

Clause 17—The method of clauses 13-16, further comprising: training the shared image feature encoder with learnable camera-specific positional embeddings.

Clause 18—The method of clauses 13-17, wherein generating the respective feature vectors from each of the multiple camera images, further comprises: generating one respective feature vector from each of the multiple camera images associated with each of a front-facing camera, a rear-facing camera, a left-facing camera, and a right-facing camera of a vehicle using the camera-specific positional embeddings associated with the different respective cameras used to capture the multiple camera images.

Clause 19—The method of clauses 13-18, further comprising: controlling a vehicle using an output of the perception task using an advanced driver assistance system (ADAS).

Clause 20—A non-transitory computer-readable medium storing instructions that, when executed, cause processing circuitry to: obtain image data including a current set of multiple camera images from multiple cameras; generate respective feature vectors from each of the multiple camera images with a shared image feature encoder using camera-specific positional embeddings associated with different respective cameras used to capture the multiple camera images; and perform a perception task using the respective feature vectors.

Clause 21—A computer program product comprising one or more instructions that, when executed by at least one processor, causes the at least one processor to perform any of the methods of clauses 13-19.

Clause 22—An apparatus comprising means for performing any combination of techniques of clauses 13-19.

It is to be recognized that depending on the example, certain acts or events of any of the techniques described herein may be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and applied by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be applied by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus for processing image data, the apparatus comprising:
a memory for storing the image data; and
processing circuitry in communication with the memory, wherein the processing circuitry is configured to:
obtain the image data including a current set of multiple camera images from multiple cameras;
generate respective feature vectors from each of the multiple camera images with a shared image feature encoder using camera-specific positional embeddings associated with different respective cameras used to capture the multiple camera images; and
perform a perception task using the respective feature vectors.

2. The apparatus of claim 1, wherein to perform the perception task using the respective feature vectors, the processing circuitry is further configured to:
generate birds-eye-view (BEV) features from the respective feature vectors; and
process the BEV features using a task-specific perception decoder to perform the perception task.

3. The apparatus of claim 1, wherein the processing circuitry is further configured to:
train the shared image feature encoder with the camera-specific positional embeddings associated with the different respective cameras, wherein the camera-specific positional embeddings are fixed.

4. The apparatus of claim 3, wherein to train the shared image feature encoder with the camera-specific positional embeddings, the processing circuitry is further configured to:
input the fixed camera-specific positional embeddings having a respective sinusoid for each of the different respective cameras, wherein a length of each of the fixed camera-specific positional embeddings varies according to which layer of the shared image feature encoder each of the fixed camera-specific positional embeddings are added or concatenated with output from the respective layer of the shared image feature encoder.

5. The apparatus of claim 1, wherein the processing circuitry is further configured to:
train the shared image feature encoder with learnable camera-specific positional embeddings.

6. The apparatus of claim 5, wherein to train the shared image feature encoder with the learnable camera-specific positional embeddings, the processing circuitry is further configured to:
initialize the learnable camera-specific positional embeddings using one-hot encoding with all positions of a first camera-specific positional embedding initialized to a value of zero (0) except for a first specified embedding and with all positions of a second camera-specific positional embedding initialized to a value of one (1) except for a second specified embedding; and
iteratively modify the values of the first camera-specific positional embedding and the values of the first camera-specific positional embedding to reduce computed losses using the first camera-specific positional embedding and the second camera-specific positional embedding after each iterative modification when compared with a ground truth.

7. The apparatus of claim 5, wherein to train the shared image feature encoder with the learnable camera-specific positional embeddings, the processing circuitry is further configured to:
initialize the learnable camera-specific positional embeddings using random initialization of values of the learnable camera-specific positional embeddings; and
iteratively modify the values of the learnable camera-specific positional embeddings to reduce losses computed after each iterative modification when compared with a ground truth.

8. The apparatus of claim 5, wherein to train the shared image feature encoder with the learnable camera-specific positional embeddings, the processing circuitry is further configured to:
back-propagate the learned camera-specific positional embeddings associated with the different respective cameras during training;
perturb weights of the shared image feature encoder based on the learnable camera-specific positional embeddings associated with the different respective cameras learned during a prior training epoch; and
re-learn the learnable camera-specific positional embeddings associated with the different respective cameras using the perturbed weights of the shared image feature encoder.

9. The apparatus of claim 1, wherein to generate the respective feature vectors from each of the multiple camera images, the processing circuitry is further configured to:
generate one respective feature vector from each of the multiple camera images associated with each of a front-facing camera, a rear-facing camera, a left-facing camera, and a right-facing camera of a vehicle using the camera-specific positional embeddings associated with the different respective cameras used to capture the multiple camera images.

10. The apparatus of claim 1, wherein to perform the perception task using the respective feature vectors, the processing circuitry is further configured to perform one or more perception tasks selected from a group comprising:
lane detection and tracking using the respective feature vectors;
traffic sign recognition using the respective feature vectors;
traffic light recognition using the respective feature vectors;
pedestrian detection using the respective feature vectors;
vehicle detection using the respective feature vectors;
road surface detection using the respective feature vectors;
crosswalk detection using the respective feature vectors; or
road hazard detection using the respective feature vectors.

11. The apparatus of claim 1, wherein the processing circuitry is further configured to:
control a vehicle using an output of the perception task.

12. The apparatus of claim 1, wherein the processing circuitry and the memory are part of an advanced driver assistance system (ADAS).

13. A method of processing image data comprising:
obtaining image data including a current set of multiple camera images from multiple cameras;
generating respective feature vectors from each of the multiple camera images with a shared image feature encoder using camera-specific positional embeddings associated with different respective cameras used to capture the multiple camera images; and
performing a perception task using the respective feature vectors.

14. The method of claim 13, wherein performing the perception task using the respective feature vectors, further comprises:
generating birds-eye-view (BEV) features from the respective feature vectors; and
processing the BEV features using a task-specific perception decoder to perform the perception task.

15. The method of claim 13, further comprising:
training the shared image feature encoder with the camera-specific positional embeddings associated with the different respective cameras, wherein the camera-specific positional embeddings are fixed.

16. The method of claim 13, wherein to training the shared image feature encoder with the camera-specific positional embeddings, further comprises:
inputting the fixed camera-specific positional embeddings having a respective sinusoid for each of the different respective cameras, wherein a length of each of the fixed camera-specific positional embeddings varies according to which layer of the shared image feature encoder each of the fixed camera-specific positional embeddings are added or concatenated with output from the respective layer of the shared image feature encoder.

17. The method of claim 13, further comprising:
training the shared image feature encoder with learnable camera-specific positional embeddings.

18. The method of claim 13, wherein generating the respective feature vectors from each of the multiple camera images, further comprises:
generating one respective feature vector from each of the multiple camera images associated with each of a front-facing camera, a rear-facing camera, a left-facing camera, and a right-facing camera of a vehicle using the camera-specific positional embeddings associated with the different respective cameras used to capture the multiple camera images.

19. The method of claim 13, further comprising:
controlling a vehicle using an output of the perception task using an advanced driver assistance system (ADAS).

20. A non-transitory computer-readable medium storing instructions that, when executed, cause processing circuitry to:
obtain image data including a current set of multiple camera images from multiple cameras;
generate respective feature vectors from each of the multiple camera images with a shared image feature encoder using camera-specific positional embeddings associated with different respective cameras used to capture the multiple camera images; and
perform a perception task using the respective feature vectors.
